(19) United States
(12) Patent Application Publication
(10) Pub. No.: US 2025/0249789 A1
(43) Pub. Date: Aug. 7, 2025

(54) BATTERY SYSTEM

(71) Applicant: SUBARU CORPORATION, Tokyo (JP)

(72) Inventor: Daichi AKIYAMA, Tokyo (JP)

(21) Appl. No.: 19/191,005

(22) Filed: Apr. 28, 2025

Related U.S. Application Data
(63) Continuation of application No. PCT/JP2023/034730, filed on Sep. 25, 2023.

(51) Int. Cl. B60L 58/12; B60L 50/60; B60L 58/18; H01M 10/42; H01M 50/209; H01M 50/242; H01M 50/249

(52) U.S. Cl. CPC B60L 58/12; B60L 50/60; H01M 10/425; H01M 50/209; H01M 50/242; H01M 50/249; B60L 58/18; B60L 2240/547; B60L 2240/549; H01M 2220/20

(57) ABSTRACT

A battery system includes: a battery including battery cells; a pressure element; a processor; and a relay. The processor is configured to perform a first drive control of the pressure element configured to apply a pressure to the battery cells. The first drive control is designed to perform one set or multiple sets of driving that increases an amount of application of the pressure by the pressure element and driving that decreases the amount of application of the pressure by the pressure element, in an order of the driving that increases the amount of application of the pressure and the driving that decreases the amount of application of the pressure, or in an order opposite to the order. The processor is configured to receive data indicating an open state or a close state of the relay, and perform the first drive control when the relay is in the open state.

### CROSS-REFERENCE TO RELATED APPLICATIONS

This application is continuation of International Application No. PCT/JP2023/034730, filed on Sep. 25, 2023, the entire contents of which are hereby incorporated by reference.

### BACKGROUND

The disclosure relates to a battery system that is to be mounted on an electric vehicle and supplies electric power usable for traveling.

Japanese Unexamined Patent Application Publication (Translation of PCT Application) (JP-T) No. 2021-516429 discloses a battery assembly including a driving device that applies a pressure to pouched battery cells. The pouched battery cell filled with an electrolytic solution is held under pressure. The battery assembly disclosed in JP-T No. 2021-516429 allows for application of the pressure to the pouched battery cell even during an operation of the battery cell.

### SUMMARY

An aspect of the disclosure provides a battery system to be mounted on an electric vehicle and configured to supply electric power usable for traveling of the electric vehicle. The battery system includes a battery, a pressure element, a processor, and a relay. The battery includes battery cells. The pressure element is configured to apply a pressure to the battery cells. The processor is configured to perform a first drive control of the pressure element. The relay is configured to open and close an electric power line between the battery and an electric device. The first drive control is designed to perform one set or multiple sets of driving that increases an amount of application of the pressure by the pressure element and driving that decreases the amount of application of the pressure by the pressure element, in an order of the driving that increases the amount of application of the pressure and the driving that decreases the amount of application of the pressure, or in an order opposite to the order of the driving that increases the amount of application of the pressure and the driving that decreases the amount of application of the pressure. The processor is configured to receive data that indicates an open state or a close state of the relay. The processor is configured to perform the first drive control when the relay is in the open state.

An aspect of the disclosure provides a battery system to be mounted on an electric vehicle and configured to supply electric power usable for traveling of the electric vehicle. The battery system includes a battery, a pressure element, and a processor. The battery includes battery cells. The pressure element is configured to apply a pressure to the battery cells. The processor is configured to perform a first drive control of the pressure element. The first drive control is configured to perform one set or multiple sets of driving that increases an amount of application of the pressure by the pressure element and driving that decreases the amount of application of the pressure by the pressure element, in an order of the driving that increases the amount of application of the pressure and the driving that decreases the amount of application of the pressure, or in an order opposite to the order of the driving that increases the amount of application of the pressure and the driving that decreases the amount of application of the pressure. The processor is configured to change a pattern of application of the pressure by the first drive control, based on one or more of a temperature of the battery, a voltage of the battery, and a state of charge of the battery that are upon starting of the first drive control.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a block diagram illustrating an electric vehicle in which a battery system according to one example embodiment of the disclosure is mounted.

FIG. 2A is a perspective diagram illustrating an internal structure of a battery.

FIG. 2B is an exploded perspective diagram illustrating a part of the internal structure of the battery.

FIG. 3 is a graph illustrating an influence of a polarization of the battery.

FIG. 4 is a diagram illustrating an action of increasing or decreasing an amount of application of pressure on a battery cell.

FIG. 5A is a flowchart illustrating a starting process of the battery system to be performed by a processor.

FIG. 5B is a flowchart illustrating an ending process of the battery system to be performed by the processor.

FIG. 6 is a flowchart illustrating in detail of a polarization reduction process of step S3 illustrated in FIG. 5A and step S13 illustrated in FIG. 5B.

FIG. 7 is a diagram illustrating examples of a pressure-application pattern by a first drive control of a pressure element.

### DETAILED DESCRIPTION

A polarization can occur in a battery. Various concerns arise when the polarization occurs, such as a reduction in an estimation accuracy of a state of charge (SOC).

It is desirable to provide a battery system that makes it possible to promptly reduce a polarization of a battery even when the polarization of the battery occurs.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

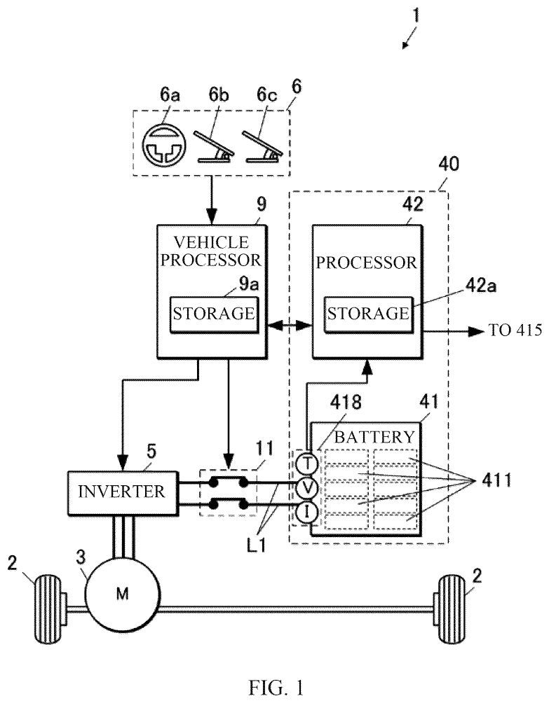

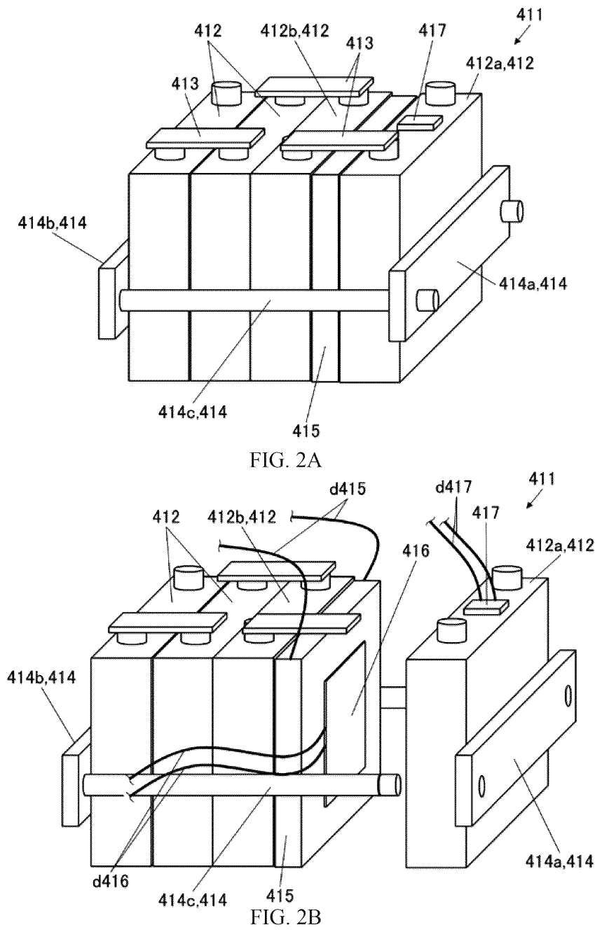

FIG. 1 is a block diagram illustrating an electric vehicle in which a battery system of the example embodiment is mounted. FIG. 2A is a perspective diagram illustrating an internal structure of a battery. FIG. 2B is an exploded perspective diagram illustrating a part of the internal structure of the battery.

The electric vehicle 1 may include drive wheels 2, a traveling motor 3, a battery system 40, an inverter 5, a traveling operation member 6, a vehicle processor 9, and a relay 11. The traveling motor 3 may drive the drive wheels 2. The battery system 40 is a battery system according to any embodiment of the disclosure. The inverter 5 may convert electric power between a battery 41 of the battery system 40 and the traveling motor 3. The traveling operation member 6 may allow for an operation of traveling of the electric vehicle 1. The vehicle processor 9 may control the traveling. The relay 11 opens and closes an electric power line LI between the battery 41 and an electric device. Non-limiting examples of the electric device may include the inverter 5. The traveling operation member 6 may include: a steering operation member 6a such as a steering wheel; an accelerator operation member 6b such as an accelerator pedal; and a brake operation member 6c such as a brake pedal. The traveling motor 3 may be an electric motor. In some embodiments, the relay 11 may be a contactor. The relay may be referred to as a system main relay.

In some embodiments, the vehicle processor 9 may be an electronic control unit (ECU). The vehicle processor 9 may operate in accordance with a control program stored in the storage 9a. The vehicle processor 9 may receive an operation signal from the traveling operation member 6 and control the inverter 5 in response to the operation signal to drive the traveling motor 3. The vehicle processor 9 may control opening and closing of the relay 11. For example, the vehicle processor 9 may switch the relay 11 to a closed state when a system of the electric vehicle 1 is to be stated up, and switch the relay 11 to an open state when the system of the electric vehicle 1 is to be ended.

The battery system 40 includes a battery 41 that supplies electric power usable for the traveling, and a processor 42 that manages a state of the battery 41.

The battery 41 may contain battery modules 411 in a housing. Referring to FIGS. 2A and 2B, the battery modules 411 each may have modularized battery cells 412. The battery cells 412 of the battery 41 each may be any secondary battery such as a lithium ion secondary battery, and include an electrolytic solution. Note that the battery cell 412 is not limited to the battery cell of the lithium ion secondary battery, and may be any of various battery cells as long as the battery cell includes the electrolytic solution.

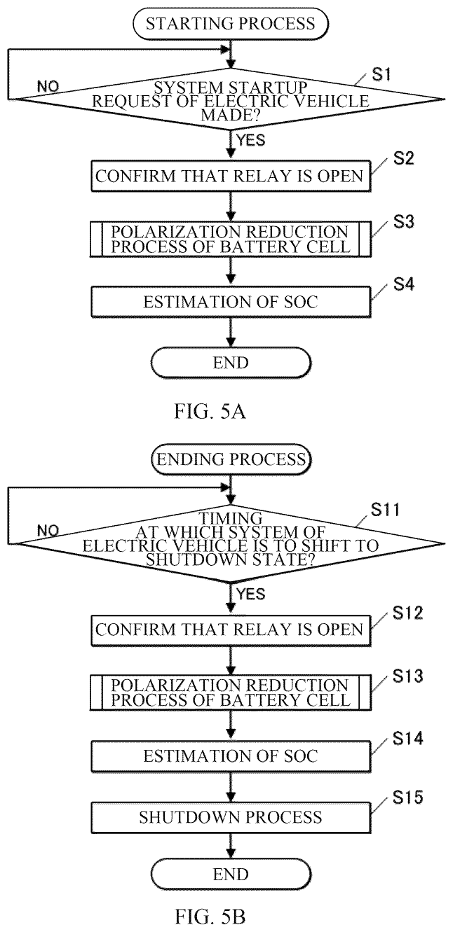

In some embodiments, the battery cells 412 may be disposed side by side in the battery module 411 in a thickness direction. As used herein, the term “thickness direction” may refer to a direction having the smallest dimension among three directions of a height direction, a width direction, and a depth direction of the battery cell 412. Referring to FIG. 5, the battery cell 412 may include a strip-shaped separator A1 and strip-shaped inner electrodes A2 and A3. The separator A1 and the inner electrode A2 and A3 may extend in two directions intersecting the thickness direction. For example, the separator A1 and the inner electrode A2 and A3 may extend in two directions orthogonal to each other. The battery cell 412 may be referred to as a laminated battery cell.

In some embodiments, the battery cells 412 in the battery module 411 may be restrained by a restraint 414 with a pressure being applied to the battery cells 412 by the restraint 414 in the thickness direction. The restraint 414 may have any structure. In some embodiments, the restraint may have two restraint plates 414a and 414b and a connector 414c, and the connector 414c may couple the two restraint plates 414a and 414b to each other with a predetermined distance therebetween.

Electrodes may be provided above the battery cells 412. The electrodes may be electrically coupled to each other in a predetermined wiring pattern. A wiring 413 that couples the electrodes may be any member such as a bus bar or a flexible conductor. A distance between the electrodes does not change significantly, or involves a small change, even when the pressure applied to the battery cells 412 changes. In some embodiments, the thus-restrained battery cells 412 may be contained in the housing to form a single battery module 411.

The battery module 411 includes a pressure element 415 that applies a pressure to the battery cells 412. The pressure element 415 may have any configuration as long as the pressure element 415 makes it possible to apply the pressure to the battery cells 412 and increase or decrease the pressure. In some embodiments, the pressure element 415 may be a plate-shaped piezoelectric element as illustrated in FIGS. 2A and 2B. The pressure element 415 may change its thickness in response to application of a voltage. The pressure element 415 may be positioned between a pair of first battery cell 412a and second battery cell 412b adjacent to each other among the battery cells 412 restrained by the restraint 414. Accordingly, when the pressure element 415 is driven to increase the thickness of the pressure element 415, the pressure in the thickness direction of the battery cells 412 increases. When the pressure element 415 is driven to reduce the thickness of the pressure element 415, the pressure in the thickness direction of the battery cells 412 decreases.

In an illustrated example embodiment of FIGS. 2A and 2B, the pressure element 415 may have substantially the same dimensions (in a range of ±10%) as the single battery cell 412 in the height direction and the width direction, and may apply the uniform pressure to the battery cells 412 in the height direction and the width direction. This configuration helps to reduce an unevenness in the pressure to be applied to the battery cells 412 by the pressure element 415. In some embodiments, the pressure element 415 may apply the pressure to a part of a range in the height direction of the battery cells 412 or a part of a range in the width direction of the battery cells 412. The application of the pressure to a part of the range helps to move the electrolytic solution from the range to another range inside the battery cell 412, which in turn helps to further achieve an agitation of the electrolytic solution. The number of pressure elements 415 is not limited to one for one battery module 411. In some embodiments, the pressure elements 415 may be disposed between the battery cells 412 included in the single battery module 411.

The battery module 411 may further include a pressure sensor 416 that detects a pressure-application force to be applied to the battery cells 412. In some embodiments, the pressure sensor 416 may be a piezoelectric element. The pressure sensor 416 may be disposed between the pressure element 415 and the second battery cell 412b or between a pair of adjacent battery cells 412. The pressure sensor 416 may detect the pressure of the battery cells 412 to be increased or decreased by the pressure element 415.

The battery module 411 may further include a temperature sensor 417. The temperature sensor 417 may be disposed in the battery module 411 and detect a temperature of the battery cells 412. The temperature sensor 417 may detect the temperature of any one of the battery cells 412 in the battery module 411 as a representative temperature.

In some embodiments, the processor 42 may be an ECU. The processor 42 may operate in accordance with control programs stored in the storage 42a. The processor 42 performs a first drive control of the pressure element 415. The first drive control performs one set or multiple sets of driving that increases the amount of application of the pressure by the pressure element 415 and driving that decreases the amount of application of the pressure by the pressure element 415, in the order of the driving that increases the amount of application of the pressure and the driving that decreases the amount of application of the pressure, or in the order opposite to the order of the driving that increases the amount of application of the pressure and the driving that decreases the amount of application of the pressure. The pressure sensor 416 and the temperature sensor 417 may transmit their respective outputs to the processor 42. Note that, in FIG. 2A, a wiring d415 that outputs the voltage by which the pressure element 415 is to be driven and wiring d416 and d417 through which the sensor signals from the pressure sensor 416 and the temperature sensor 417 are to be transmitted are omitted.

The processor 42 may serve as a battery control unit (BCU) that manages a state of the battery 41. The processor 42 as the BCU may receive measurement values of a current, a voltage, and a temperature of the battery 41, and manage a factor such as a state of charge (SOC), a dischargeable electric power Wout, or a chargeable electric power Win of the battery 41. The battery 41 may include a sensor 418 that measures the current, the voltage, and the temperature of the battery 41, and output a result of the measurements to the processor 42. The processor 42 may manage the SOC of the battery 41 by integrating the current of the battery 41. The processor 42 may have a data table or a calculation formula representing a relationship between the voltage (e.g., OCV: Open Circuit Voltage) and the SOC, and estimate the SOC based on the data table or the calculation formula and the voltage.

In some embodiments, the processor 42 that performs the first drive control of the pressure element 415 may not serve as the BCU, and the processor 42 and the BCU may be provided as separate ECUs. In this example, the processor 42 and the BCU may be configured to communicate and cooperate with each other. In some embodiments, the processor 42 that performs the first drive control of the pressure element 415 may be integrated into the vehicle processor 9, and the vehicle processor 9 may perform all or a part of operations of the processor 42. Hereinafter, a non-limiting configuration in which the processor 42 also serves as the BCU will be described.

### <Characteristics of Battery>

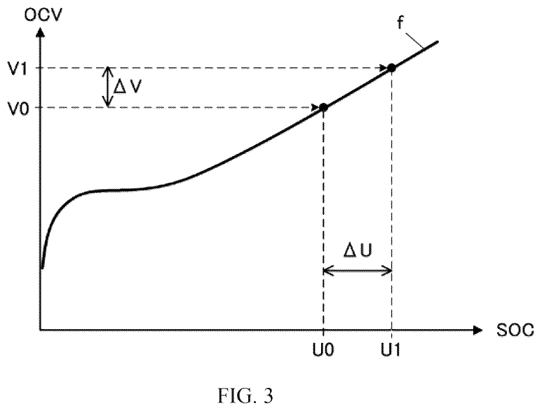

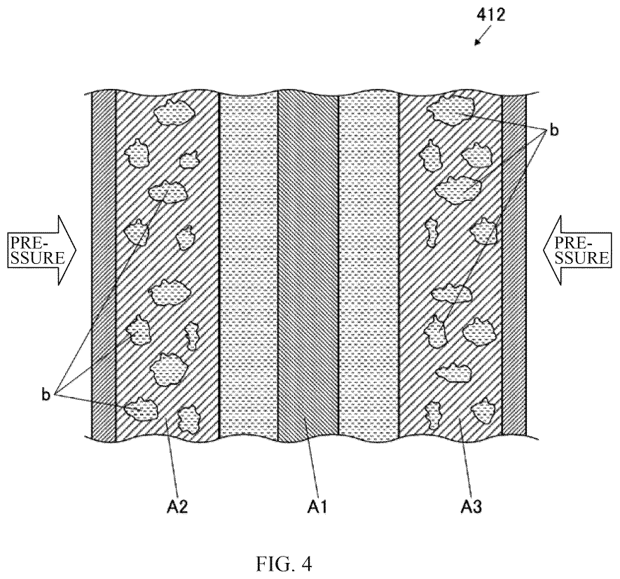

FIG. 3 is a graph illustrating an influence of a polarization of the battery 41. FIG. 4 is a diagram illustrating an action of increasing or decreasing the amount of application of the pressure on the battery cell.

The degree of polarization of the battery 41 can become high due to energization. The term “polarization” may refer to a phenomenon in which an actual voltage deviates from a voltage at equilibrium of the battery 41. A voltage V0 of FIG. 3 represents a voltage at the equilibrium of the battery 41. A relationship curve “f” in FIG. 3 represents a relationship between the voltage at the equilibrium and the SOC of the battery 41. If the voltage V0 at the equilibrium is known, it is possible to estimate an actual SOC_U0 with high accuracy by using a calculation equation or a data table that represents the relationship between the voltage and the SOC of the battery 41. When a polarization ΔV is occurred, however, a voltage VI obtained from the output of the sensor 418 deviates from the voltage V0 at the equilibrium. Accordingly, determining the SOC using the calculation equation or the data table can include an error ΔU of the polarization ΔV in the thus-determined SOC_U1 as compared with the correct SOC_U0.

Non-limiting examples of a factor of the polarization may include an occurrence of imbalance in a concentration of ions contained in the electrolytic solution in the vicinity of the inner electrodes A2 and A3 of the battery cell 412. Referring to FIG. 4, a large number of pores “b” are provided in the inner electrodes A2 and A3 included in the battery cell 412, and the inner electrodes A2 and A3 are impregnated with the electrolytic solution. The degree of polarization can increase due to the imbalance in the ionic concentration in the electrolytic solution of the pores b.

Applying the pressure to the battery cells 412 in the thickness direction and so changing the application of the pressure as to increase or decrease a pressure-application force of the pressure application when the degree of polarization is increased makes it possible to decrease the volume of the pores b of the inner electrodes A2 and A3 and to increase the volume of the pores b of the inner electrodes A2 and A3 thereafter. Such an action causes an agitation of the electrolyte solution, making it possible to decrease the imbalance in the ionic concentration of the electrolyte solution in the vicinity of the inner electrodes A2 and A3 and quickly reduce the polarization.

### <Starting Process and Ending Process of Battery System>

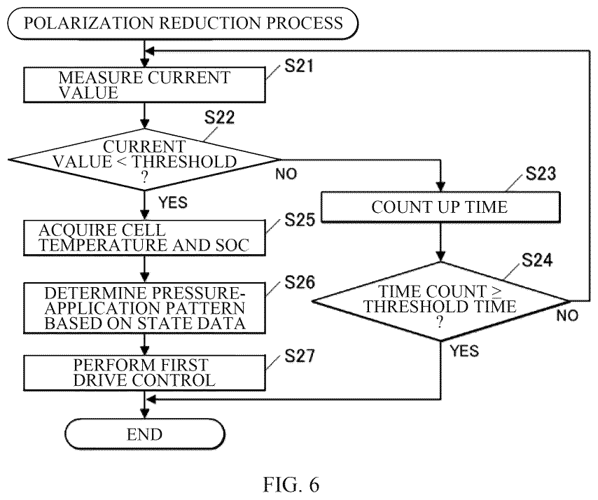

FIG. 5A is a flowchart illustrating a starting process of the battery system 40 to be performed by the processor 42. FIG. 5B is a flowchart illustrating an ending process of the battery system 40 to be performed by the processor 42. FIG. 6 is a flowchart illustrating in detail of a polarization reduction process of step S3 illustrated in FIG. 5A and step S13 illustrated in FIG. 5B.

When the electric vehicle 1 is in a shutdown state, the processor 42 may initiate the starting process illustrated in FIG. 5A. In the starting process, the processor 42 may first repeat a process (step S1) of determining whether a system startup request of the electric vehicle 1 is made until a result indicating YES is obtained. For example, the system startup request is made when a power button of the electric vehicle 1 is turned on by a user.

If the result indicating YES is obtained in step S1, the processor 42 may first communicate with the vehicle processor 9 to confirm that the relay 11 is in an open state (step S2). When the system startup request of the electric vehicle 1 is made, normally, the relay 11 is in the open state and is confirmed as being in the open state in step S2. If the relay 11 is confirmed as not being in the open state due to a particular situation in step S2, the processor 42 may send, to the vehicle processor 9, a request to open the relay 11 and control the relay 11 to be in the open state once. Alternatively, if the relay 11 is not confirmed as being in the open state in step S2, the processor 42 may skip step S3 and advance the process to step S4. Still alternatively, if the relay 11 is not confirmed as being in the open state in step S2, the processor 42 may skip steps S3 and S4 and end the starting process.

If it is confirmed in step S2 that the relay 11 is in the open state, the processor 42 may perform the polarization reduction process (step S3). Referring to FIG. 6, in the polarization reduction process, the processor 42 may first measure a value of the current, i.e., a current value, of the battery 41 (step S21). Even when the relay 11 is open, the current of the battery 41 may sometimes not be completely zero; accordingly, in step S21, the processor 42 may measures the current value. Note that the current value to be measured in step S21 may not be the current value between the two terminals of the battery 41. The current value may be a value of an internal current flowing between the battery modules 411 or between the battery cells 412.

The processor 42 may determine whether the current measured in step S21 is less than a threshold (step S22). The threshold may be set to a value that ensures that a performance deterioration of the battery cell 412 falls within an allowable range even if the pressure-application amount of the battery cell 412 changes.

If a result of step S22 indicates NO, the processor 42 may perform a clocking process (step S23), and determine whether the total clocking time of step S23 has passed the threshold time (step S24). If the total clocking time has not passed the threshold time (step S24: NO), the processor 42 may return the process to step S21. If the threshold time has passed the threshold time (step S24: YES), the processor 42 may end the polarization reduction process in order to omit the drive of the polarization reduction, and advance the process to step S4 illustrated in FIG. 5A.

If the result of step S22 indicates YES, the processor 42 may acquire the temperature of the battery cell 412 (hereinafter, referred to as a “cell temperature”), the voltage of the battery 41, and the SOC of the battery 41 (step S25). The SOC to be acquired in step S25 may not be a value representing the current SOC with a high accuracy, such as the SOC converted from the voltage of the battery 41 or the current SOC calculated based on the SOC acquired last time in the battery system 40.

The processor 42 may determine a pattern of application of the pressure, i.e., a pressure-application pattern, by the first drive control of the pressure element 415, based on one or more of the cell temperature, the voltage, and the SOC obtained in step S25 (step S26).

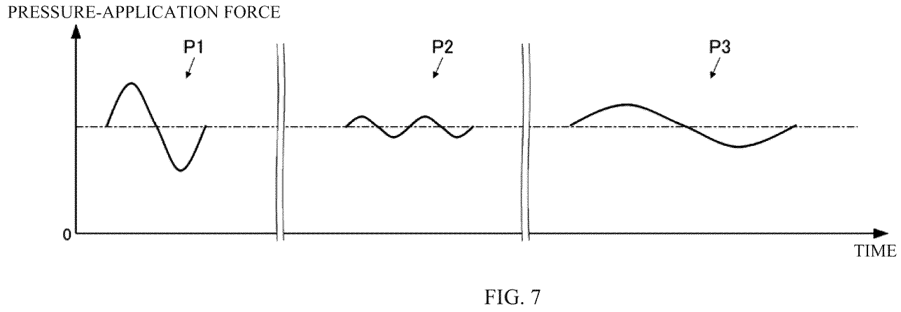

FIG. 7 is a diagram illustrating examples of the pressure-application pattern by the first drive control of the pressure element 415. As described above, the first drive control performs one set or multiple sets of driving that increases the amount of application of the pressure by the pressure element 415 and driving that decreases the amount of application of the pressure by the pressure element 415, in the order of the driving that increases the amount of application of the pressure and the driving that decreases the amount of application of the pressure, or in the order opposite to the order of the driving that increases the amount of application of the pressure and the driving that decreases the amount of application of the pressure. In some embodiments, the processor 42 may employ multiple pressure-application patterns upon performing the first drive control. For example, as indicated by pressure-application patterns P1 to P3 of FIG. 7, the processor 42 may create the multiple pressure-application patterns, by changing a factor such as an absolute value of the pressure-application amount (such as a maximum value and a minimum value), the number of times of increasing or decreasing the pressure-application amount, or a speed of changing the pressure-application amount, or by making two or more of these factors different.

In the battery 41, the degree of polarization of the battery cells 412 tends to decrease when the cell temperature is high, and the degree of polarization of the battery cells 412 tends to increase when the cell temperature is low. Accordingly, in some embodiments, the pressure-application pattern may be selected in which the higher the cell temperature, the lower the maximum value of the pressure-application amount, and the lower the cell temperature, the higher the maximum value of the pressure-application amount, if there is no difference in other parameters.

When the SOC is high, an expansion amount of the battery cells 412 tends to increase, and the expansion amount of the battery cells 412 tends to decrease when the SOC is low. In addition, when the SOC is within a certain range, a slope of a relationship curve between the SOC and the expansion of the battery cells 412 may sometimes be reversed. Accordingly, in some embodiments, the pressure-application pattern may be selected in which the maximum value of the pressure-application amount becomes relatively low if the SOC involves the large expansion amount, and the maximum value of the pressure-application amount becomes relatively high if the SOC involves the small expansion amount, if there is no difference in other parameters.

When the voltage is high, the amount of expansion of the battery cells 412 tends to increase, and when the voltage is low, the amount of expansion of the battery cells 412 tends to decrease. Accordingly, in some embodiments, the pressure-application pattern may be selected in which the higher the voltage, the lower the maximum value of the pressure-application amount, and the lower the voltage, the higher the maximum value of the pressure-application amount, if there is no difference in other parameters.

If it is difficult to increase the maximum value of the pressure-application amount based on the voltage or the SOC while the degree of polarization is large due to the low cell temperature, the pressure-application pattern may be selected in which the number of times of increasing or decreasing the pressure-application amount is increased while the maximum value of the pressure-application amount is decreased. In some embodiments, the pressure-application pattern may be selected in which the speed of change of the pressure-application amount is decreased while the maximum value of the pressure-application amount is increased to a moderate level.

Selecting any of the example pressure-application patterns as described above helps to exert the agitation of the electrolytic solution while suppressing the deterioration of the battery cells 412, and to reduce the polarization of the battery 41. The storage 42a of the processor 42 may be provided with a data table that achieves any selection of the example pressure-application pattern as described above.

In step S26, the processor 42 may determine the pressure-application pattern of the pressure element 415 that is based on state data of the battery 41, by referring to the state data of the battery 41 in the data table. Non-limiting examples of the state data may include the cell temperature, the SOC, and the voltage.

After the pressure-application pattern is determined in step S26, the processor 42 may perform the first drive control that drives the pressure element 415 to cause the pressure-application force based on the pressure-application pattern is generated (step S27).

Referring to FIG. 4, the battery cells 412 may be subjected to the application of pressure in the thickness direction and the pressure-application force is changed to increase or decrease by the first drive control in step S27. The pressure-application force may cause the volume of the pores b of the inner electrodes A2 and A3 to be reduced and subsequently increased, or vice versa, and the electrolytic solution is agitated. The agitation of the electrolytic solution reduces the imbalance of the ionic concentration of the electrolytic solution in the vicinity of the inner electrodes A2 and A3, which helps to promptly reduce the polarization of the battery cells 412.

Note that the pressure-application pattern of steps S26 and S27 is not limited to the above-described example. Various pressure-application patterns may be adopted as long as the pressure-application pattern increases or decreases the pressure-application force with the passage of time.

When the first drive control of step S27 is completed, the processor 42 may end the polarization reduction process and advance the process to the subsequent step of FIG. 5. The processor 42 may perform an estimation process of the SOC (step S4). In step S4, the processor 42 may acquire an estimation value of the SOC by measuring the OCV of the battery 41 from the sensor 418 and applying the thus-acquired OCV to a data table or a calculation formula.

The processor 42 may end the starting process of the battery system 40. When the system of the electric vehicle 1 is started up, the processor 42 may shift the process to a battery management process. The battery management process may manage the SOC at the time of traveling of the electric vehicle 1, by adding, to the highly accurate SOC acquired by the processor 42 in the starting process, an amount of the change in the SOC that is based on a current integrated value obtained thereafter. Accordingly, even the battery management process helps to achieve a highly accurate management of the SOC.

When the system of the electric vehicle 1 is started up and the starting process of the battery system 40 is ended, the processor 42 may initiate the ending process of the battery system 40 illustrated in FIG. 5B. The processor 42 may repeat, along with the battery management process, a process (step S11) of determining a timing at which the system of the electric vehicle 1 is to shift to a shutdown state until a result indicating YES is obtained. For example, the timing at which the system of the electric vehicle 1 shifts to the shutdown state is satisfied based on a system ending operation of the electric vehicle 1 operated by the user.

If the timing at which the system of the electric vehicle 1 shifts to the shutdown state is satisfied and the result indicating YES is obtained in step S11, the processor 42 may first communicate with the vehicle processor 9 to confirm that the relay 11 is in the open state (step S12). Normally, the relay 11 is placed into the open state at the timing at which the electric vehicle 1 shifts to the shutdown state; accordingly, the relay 11 is confirmed as being in the open state in step S12. If the relay 11 is not confirmed as being in the open state in step S12, the processor 42 may stand by for a predetermined time and perform the process of confirming whether the relay 11 is placed into the open state again. Alternatively, if the relay 11 is not confirmed as being in the open state in step S12, the processor 42 may skip step S13 and advance the process to step S14. Still alternatively, if the relay 11 is not confirmed as being in the open state in step S12, the processor 42 may skip steps S13 and S14 and advance the process to step S15.

If the relay 11 is confirmed as being in the open state in step S12, the processor 42 may perform the polarization reduction process (step S13). The polarization reduction process of step S13 may be similar to the polarization reduction process of step S3 illustrated in FIG. 5A.

The processor 42 may perform an estimation process of the SOC (step S14). In step S14, the processor 42 may acquire an estimation value of the SOC by measuring the OCV of the battery 41 from the sensor 418 and applying the thus-acquired OCV to a data table or a calculation formula. The processor 42 may perform its own shutdown process (step S15), and end the ending process of the battery system 40. The ending process helps to allow the processor 42 to acquire the SOC of the battery 41 with high accuracy even at the time of completion of the traveling of the electric vehicle 1.

The program of the starting process and the ending process of the battery system 40 may be stored in a non-transitory computer readable medium such as the storage 42a of the controller 42. The controller 42 may be configured to read the program stored in a portable non-transitory recording medium and execute the program. The portable non-transitory storage medium may store the program of the starting process and the ending process of the battery system 40.

The battery system 40 according to the example embodiment includes the battery 41, the pressure element, and the processor 42. The battery 41 includes the battery cells 412. The pressure element 415 is configured to apply the pressure to the battery cells 412. The processor 42 is configured to perform the first drive control of the pressure element 415. The first drive control is configured to perform the one set or multiple sets of driving that increases the amount of application of the pressure by the pressure element 415 and driving that decreases the amount of application of the pressure by the pressure element 415, in the order of the driving that increases the amount of application of the pressure and the driving that decreases the amount of application of the pressure, or in the order opposite to the order of the driving that increases the amount of application of the pressure and the driving that decreases the amount of application of the pressure. This configuration helps to exert the agitation action of the electrolytic solution when the polarization caused by the imbalance in the ionic concentration of the electrolytic solution occurs in the battery 41, and to promptly reduce the polarization. Accordingly, this configuration helps to quickly solve various concerns resulting from the polarization, such as a deterioration in an estimation accuracy of the SOC caused by the polarization.

In some embodiments, the electric vehicle 1 may include the relay 11 configured to open and close the electric power line LI between the battery 41 and the electric device, and the processor 42 is configured to perform the first drive control of the pressure element 415 when the relay 11 is in the open state. If a current flows through the battery cells 412 when the pressure-application force of the battery cells 412 is increased or decreased by the first drive control, the deterioration degree of the battery cells 412 may sometimes progress. This configuration helps to suppress such a deterioration of the battery cells 412.

In some embodiments, the processor 42 may include a current sensor. Non-limiting examples of the current sensor may include the sensor 418 and a sensor configured to measure a current between the battery cells 412 or a current between the battery modules 411. The processor 42 may perform the first drive control of the pressure element 415, when the value of the current measured by the current sensor is equal to or less than the threshold. A current may sometimes flow in the battery 41 even when the relay 11 is in the open state. If the first drive control of the pressure element 415 is performed while the current is flowing, the deterioration degree of the battery cells 412 may sometimes progress. This configuration helps to suppress such a deterioration of the battery cells 412.

In some embodiments, the battery cells 412 may be disposed side by side in order, and the pressure element 415 may be disposed between the first battery cell 412a and the second battery cell 412b that are adjacent to each other. This configuration helps to uniformly apply the pressure to the battery cells 412 by the single pressure element 415. This configuration in turn helps to relatively suppress an increase in the volume of the battery 41 due to the addition of a configuration that applies the pressure.

In some embodiments, the processor 42 may be configured to change the pressure-application pattern of the first driving control of the pressure element 415, based on the state data. Non-limiting examples of the state data may include data on the temperature, data on the voltage, and data on the SOC of the battery 41. This configuration helps to reduce the polarization by adding, to the battery cells 412, the pressure-application pattern corresponding to a state of the battery 41. Accordingly, this configuration helps to achieve the polarization reduction process while suppressing the progress in the deterioration of the battery cells 412.

Some example embodiments of the disclosure have been described above; however, the disclosure is not limited to the above-described example embodiments. For example, in the above example embodiment, the timing at which the first drive control of the pressure element 415 may be performed is before the process of estimating the SOC. In some embodiments, the first drive control of the pressure element 415 may be performed prior to the start of charging. In some embodiments, the first drive control of the pressure element 415 may be performed after the end of the charging. In some embodiments, the first drive control of the pressure element 415 may be performed during the halt of the traveling. In some embodiments, the first drive control of the pressure element 415 may be performed at a timing not related to the process of estimating the SOC. Reducing the polarization of the battery cells 412 helps to improve an efficiency of charging and discharging the battery 41. Further, in the above-described example embodiment, the first drive control of the pressure element 415 may be performed at the time of system startup of the electric vehicle 1 and at the time of completion of the traveling. In some embodiments, the estimation process of the SOC performed in the subsequent stage of the first drive control may be omitted. Reducing the polarization of the battery cells 412 helps to improve the efficiency of charging and discharging the battery 41, and slow down the progress of deterioration of a storage period of the battery 41.

Further, in the above-described example embodiment, the pressure element 415 may expand on an inner side of the restraint 414 to apply the pressure to the battery cells 412, by utilizing the restraint 414 that restrains the battery cells 412. Various types of configurations configured to apply the pressure-application force to battery cells 412 may be adopted. In some embodiments, a configuration may be adopted in which the battery cells 412 are sandwiched and a force that sandwiches the battery cells 412 may be changed.

Although the disclosure has been described hereinabove in terms of the example embodiment and modification examples, the disclosure is not limited thereto. It should be appreciated that variations may be made in the described example embodiment and modification examples by those skilled in the art without departing from the scope of the disclosure as defined by the following claims.

The limitations in the claims are to be interpreted broadly based on the language employed in the claims and not limited to examples described in this specification or during the prosecution of the application, and the examples are to be construed as non-exclusive.

As used in this specification and the appended claims, the singular forms “a,” “an,” and “the” include, especially in the context of the claims, are to be construed to cover both the singular and the plural, unless otherwise indicated herein or clearly contradicted by context.

Throughout this specification and the appended claims, unless the context requires otherwise, the terms “comprise”, “include”, “have”, and their variations are to be construed to cover the inclusion of a stated element, integer, or step but not the exclusion of any other non-stated element, integer, or step.

The use of the terms first, second, etc. do not denote any order or importance, but rather the terms first, second, etc. are used to distinguish one element from another.

The term “substantially”, “approximately”, “about”, and its variants having the similar meaning thereto are defined as being largely but not necessarily wholly what is specified as understood by one of ordinary skill in the art.

The term “disposed on/provided on/formed on” and its variants having the similar meaning thereto as used herein refer to elements disposed directly in contact with each other or indirectly by having intervening structures therebetween.

The processor 42 illustrated in FIG. 1 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the processor 42. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the processor 42 illustrated in FIG. 1.

1. A battery system to be mounted on an electric vehicle and configured to supply electric power usable for traveling of the electric vehicle, the battery system comprising:
a battery including battery cells;
a pressure element configured to apply a pressure to the battery cells;
a processor configured to perform a first drive control of the pressure element; and
a relay configured to open and close an electric power line between the battery and an electric device, wherein
the first drive control is configured to perform one set or multiple sets of driving that increases an amount of application of the pressure by the pressure element and driving that decreases the amount of application of the pressure by the pressure element, in an order of the driving that increases the amount of application of the pressure and the driving that decreases the amount of application of the pressure, or in an order opposite to the order of the driving that increases the amount of application of the pressure and the driving that decreases the amount of application of the pressure,
the processor is configured to receive data that indicates an open state or a close state of the relay, and
the processor is configured to perform the first drive control when the relay is in the open state.

2. A battery system to be mounted on an electric vehicle and configured to supply electric power usable for traveling of the electric vehicle, the battery system comprising:
a battery including battery cells;
a pressure element configured to apply a pressure to the battery cells; and
a processor configured to perform a first drive control of the pressure element, wherein
the first drive control is configured to perform one set or multiple sets of driving that increases an amount of application of the pressure by the pressure element and driving that decreases the amount of application of the pressure by the pressure element, in an order of the driving that increases the amount of application of the pressure and the driving that decreases the amount of application of the pressure, or in an order opposite to the order of the driving that increases the amount of application of the pressure and the driving that decreases the amount of application of the pressure, and
the processor is configured to change a pattern of application of the pressure by the first drive control, based on one or more of a temperature of the battery, a voltage of the battery, and a state of charge of the battery that are upon starting of the first drive control.

3. The battery system according to claim 1, further comprising a current sensor configured to measure a current of the battery, wherein
the processor is configured to perform the first drive control when: the relay is in the open state; and a value of the current measured by the current sensor is equal to or less than a threshold.

4. The battery system according to claim 1, wherein
the battery cells are disposed side by side, and
the pressure element is disposed between a first battery cell and a second battery cell that are adjacent to each other of the battery cells.

5. The battery system according to claim 2, wherein
the battery cells are disposed side by side, and
the pressure element is disposed between a first battery cell and a second battery cell that are adjacent to each other of the battery cells.

6. The battery system according to claim 1, wherein the processor is configured to change the pattern of application of the pressure by the first drive control, based on state data of the battery.
